(19) United States
(12) Patent Application Publication
(10) Pub. No.: US 2008/0049241 A1
(43) Pub. Date: Feb. 28, 2008

(54) PRINT DATA OUTPUT DEVICE TO SELECT A PRINTER LANGUAGE AND METHOD OF SELECTING A PRINTER LANGUAGE

(75) Inventors: So-hye KIM, Suwon-si (KR); Na-young KIM, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/742,736

(22) Filed: May 1, 2007

(30) Foreign Application Priority Data
Aug. 23, 2006 (KR) 2006-79651

(51) Int. Cl. G06K 15/02

(52) U.S. Cl. 358/1.11

(57) ABSTRACT

A print data output device to select a printer language and a method of selecting a printer language are provided. According to the print data output device, a graphics device interface (GDI) unit may be used to divide print data into objects and to call associated calling functions of the objects. A printer driver may be used to collect and count the called associated calling functions collected of the objects in a corresponding count result, to select an optimum printer language among a plurality of printer languages based on the count results, to receive the objects of the print data from the GDI unit, and to convert the objects into the selected optimum printer language.

### CROSS-REFERENCE TO RELATED APPLICATIONS

This application claims the benefit under 35 U.S.C. §119 of Korean Patent Application No. 2006-79651, filed Aug. 23, 2006, in the Korean Intellectual Property Office, the disclosure of which is incorporated herein by reference in its entirety.

### BACKGROUND OF THE INVENTION

1. Field of the Invention

The present general inventive concept relates to a print data output device to select a printer language and a method of selecting a printer language. More particularly, the present general inventive concept relates to a print data output device to select a printer language and a method of selecting a printer language, which can improve print speed by selecting an optimum printer language, for example, among plural printer languages supported by a printer driver.

2. Description of the Related Art

Generally, a document prepared through an application program to be printed is converted into a printer language by a printer driver, and then transmitted to a printer to be printed. A printer generally supports one printer language, and in order to print the document, the printer and the printer driver should support the same emulation method. That is, in the case where the printer supports a printer control language (PCL) emulation, the printer driver should convert the document into the PCL printer language. In the case where the printer supports PostScript (PS) emulation, the printer driver should convert the document into the PS printer language.

However, because the conventional printer driver supports only one printer language (as described above), the printer driver is restricted to converting the document into the same printer language. That is, a conventional printer driver uses only a single designated printer language, without considering the characteristic of the document (e.g., a document consisting mainly of graphic images or a document consisting mainly of text). Accordingly, the conventional printer driver cannot select a different printer language (other than the single designated printer language) by taking into consideration the characteristic of the document (i.e., print data) to be printed.

In addition, although a print speed may be adjustable in accordance with the characteristic of a document and a selected printer language, the conventional printer driver cannot select (or choose) the type of the printer language to be used to optimize (or improve) the print speed.

### SUMMARY OF THE INVENTION

The present general inventive concept provides a print data output device to select a printer language and a method of selecting a printer language, which can improve a print speed by selecting a suitable printer language according to characteristics of the print data.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be substantially realized by providing a print data output device to select a printer language, according to one or more embodiments of the present general inventive concept, which can include a graphics device interface (GDI) unit to divide print data to be printed into objects and to call associated calling functions to output the objects, and a printer driver to collect the called associated calling functions of the objects and to count the numbers of times each associated calling function is called into a corresponding count result, to select an optimum printer language among a plurality of printer languages based the count result, to receive the objects of the print data from the GDI unit, and to convert the objects into the selected optimum printer language.

The collection of the associated calling functions may be ended when the call of the functions for a first page of the print data is completed, and the printer driver may select the optimum printer language based on the count result of counting the associated calling functions for the first page.

The printer driver may collect the functions by using a GDI banding function of the GDI unit.

If the number of the associated calling functions called corresponding to at least one object (among the respective objects) is greater than a set reference value (e.g., determined based on the count result), then the printer driver may select, as the optimum printer language, the printer language used to convert the print data into bitmap data.

If the number of the associated calling functions called corresponding to the objects is less than or equal to a set reference value (e.g., determined based on the count result), then the printer driver may select, as the optimum printer language, the printer language used to generate different commands for the objects that constitute the print data.

The selected optimum printer language may be any one of a printer control language (PCL) and a PostScript (PS).

The respective objects may be at least one of a bitmap object, a line object, a surface object, and a text object, and the printer driver may select the optimum printer language by comparing the number of the calling functions corresponding to the bitmap objects, the number of calling functions corresponding to the surface objects, the number of calling functions corresponding to the line objects, and the number of calling functions corresponding to the text objects, against a reference value, respectively.

The reference value may differ according to each of the object types noted above.

According to another embodiment of the present general inventive concept, there is provided a method of selecting a printer language, which includes dividing print data to be printed into objects having associated calling functions to output the objects using a graphics device interface (GDI), collecting the associated calling functions of the objects and counting the number of times each associated calling function is called in a corresponding count result, selecting an optimum printer language among a plurality of printer languages based on the corresponding count result, and receiving the objects of the print data from the GDI and converting the received objects into the selected optimum printer language.

The collecting of the associated calling functions may be stopped when calling for a first page of the print data is completed, and when the optimum printer language is selected based on the count result for the first page.

The counting of the associated calling functions called may include collecting the functions by using a GDI banding function of the GDI.

The selecting of the optimum printer language may include selecting the printer language to convert the print data into bitmap data as the optimum printer language if the number of the associated calling functions called corresponding to at least one object (among the respective objects) is greater than a set reference value.

The selecting of the optimum printer language may include selecting, as the optimum printer language, the printer language to generate different commands for the objects that constitute the print data if the number of associated calling functions called corresponding to the objects is less than or equal to a set reference value.

The respective objects may be at least one of a bitmap object, a line object, a surface object, and a text object, and selecting of the optimum printer language may include selecting the optimum printer language by comparing a bitmap size of the bitmap objects, the number of calling functions of the surface objects, the number of calling functions of the line objects, and the number of calling functions of the text objects, against a reference value, respectively.

The foregoing and/or other aspects and utilities of the present general inventive concept may be substantially realized by providing a print data output device to convert print data, divided into one or more objects having at least one associated call function, into a selected printer language, the device including a printer driver to tally a corresponding count result of a corresponding total number for each associated call function, to select the printer language based on the corresponding count result, and to convert the print data into the selected printer language.

The foregoing and/or other aspects and utilities of the present general inventive concept may be substantially realized by providing a print data output device to convert print data, divided into one or more different object types, into a selected printer language, the device including a printer driver to determine a corresponding count of each of the different object types, to select the printer language based on the corresponding count result, and to convert the print data using the selected printer language.

The foregoing and/or other aspects and utilities of the present general inventive concept may be substantially realized by providing a method of selecting a printer language to convert print data, divided into one or more objects having at least one associated call function, including tallying a corresponding count result of a corresponding total number for each associated call function, selecting the printer language based on the corresponding count result, and converting the print data into the selected printer language.

### BRIEF DESCRIPTION OF THE DRAWINGS

These and/or other aspects and utilitites of the present general inventive concept will become apparent and more readily appreciated from the following description of the embodiments, taken in conjunction with the accompanying drawings of which:

FIG. 1 is a view schematically illustrating a printing system including a print data output device to select a printer language according to an embodiment of the present general inventive concept;

FIG. 2 is a block diagram illustrating the detailed construction of a printer driver as illustrated in the embodiment of FIG. 1;

FIG. 3 is a flowchart illustrating a method of selecting a printer language used by the device of FIG. 1, according to an embodiment of the present general inventive concept; and

FIG. 4 is a flowchart illustrating an operation S335 of selecting an optimum printer language of FIG. 3 in more detail, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

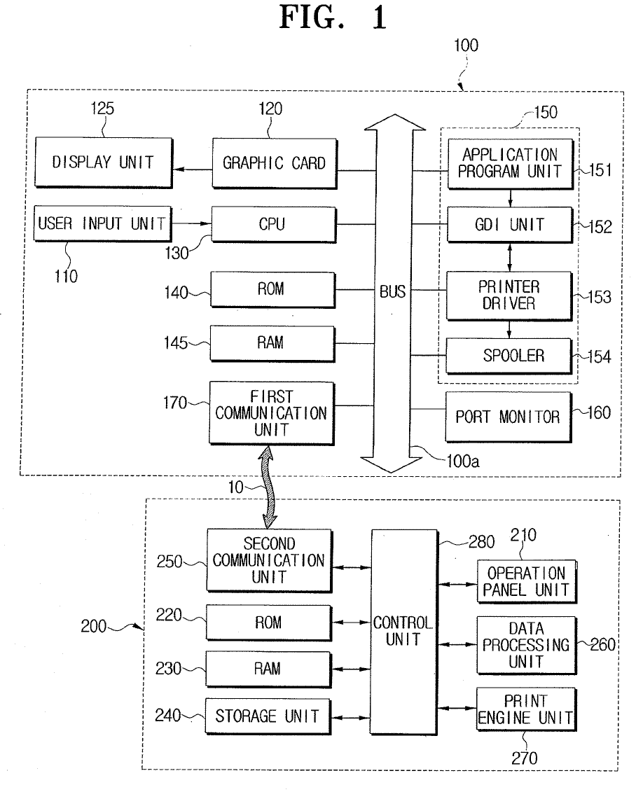

FIG. 1 is a view schematically illustrating a printing system including a print data output device to select a printer language according to an embodiment of the present general inventive concept.

Referring to FIG. 1, the printing system includes a print data output device 100 and an image forming device 200. The print data output device 100, which may be a personal computer, is used to select one of plural printer languages in consideration of the characteristic of a document (i.e. print data) to be printed, to convert the document (i.e. print data) into commands that can be interpreted by the image forming device 200 by using the selected printer language, and to transmit the converted commands to the image forming device 200 to request the printing of the document.

The image forming device 200 is a device to form an image of the document on a paper (or other suitable medium) and to print the document by using emulation corresponding to the selected printer language, and may be a printer or a multifunctional device having a printer function. The print data output device 100 and the image forming device 200 can be connected with each other through a wired or wireless network.

According to an embodiment of the present general inventive concept, the print data output device 100 may include a user input unit 110, a graphic card 120, a display unit 125, a central processing unit (CPU) 130, a ROM 140, a RAM 145, a hard disk drive (HDD) 150, a port monitor 160, and a first communication interface unit 170. A bus 100a may be used to provide data transmission paths between the above-described components, as illustrated, for example.

The user input unit 110 may be an interface to request various functions supported by the print data output device 100, and may be a keyboard, a mouse, and so forth. For example, the user input unit 110 may be used to output a signal to request the printing of a document (i.e., print data) to the CPU 130.

The graphic card 120 may be used to process (or to convert) a video signal into a displayable signal, and to output the displayable signal to the display unit 125. For example, the graphic card 120 may be used to process an image for a user interface that is provided from an application program unit or a printer driver, and may be used to output the processed image signal to the display unit 125.

The display unit 125 may be used to display an image corresponding to the signal provided, for example, from (or via) the graphic card 120 or based on an operation state of the print data output device 100.

The CPU 130 may be used to control the full operation of the print data output device 100 by using various kinds of pre-stored control programs. For example, the CPU 130 may be used to execute a program related to a printer driver if the printing of a document (i.e., print data) that may be prepared through an application program is requested through the user input unit 110.

The ROM 140may be used to store basic information needed to check respective constituent elements of the print data output device 100 before an operating system such as Windows is executed. The RAM 145may be used to store programs loaded from the ROM 140 or the HDD 150 and to be executed by the CPU 130 and data processed by the CPU 130.

The HDD 150may be used to install operating systems required to operate the print data output device 100, software, and firmware. In particular, for print jobs, the HDD 150 may include an application program unit 151, a graphics device interface (GDI) unit 152, a printer driver 153, and a spooler 154.

In the application program unit 152, application programs to enable a user to prepare various kinds of documents may be provided. In the case of printing a prepared document, the application program unit 151 may be used to provide a print request signal, print options, and/or print data of the document to be printed to the GDI unit 152. The print options may include diverse printing parameters such as the size of a printing paper (or other suitable medium), the number of copies, the direction of printing, and so forth, and the print data may include data containing images, text, lines, surfaces, and so forth. The application programs may be a Word Processor, PowerPoint, Photoshop, and so forth.

The GDI unit 152 may be a part of a Windows System of the Microsoft Corporation that is used as a computer operating system, to support an interface between the application program unit 151 and the printer driver 153, and to provide a GDI banding function.

The GDI banding function may be used to divide a page (i.e., of print data) into a plurality of regions and to transmit the data in accordance with the divided regions, as a precaution against the instance when the printer driver 153 cannot process all the print data received from the GDI unit 152 at once. That is, the GDI banding function may be used to transmit the objects of the regions that can be processed by the printer driver 153 and to call the associated calling functions of the objects for the printer driver 153.

First, the GDI unit 152 may be used to transfer the printing parameters provided, for example, from the application program unit 151 to the printer driver 153. Then, the GDI unit 152 may be used to call the associated device driver interface (DDI) calling functions of the objects, which functions are supported by the printer driver 153, using DDI function names. The associated DDI calling functions are used to output the respective objects that constitute the print data, i.e., line objects, surface objects, text objects, and bitmap image objects.

Table 1 below illustrates non-limiting examples of associated DDI calling functions of the objects (that may be called).

TABLE 1

| Object | |
|---|---|
| Included | |
| in Document | DDI Function Corresponding to Objects |
| Text | DrvTextOut Function |
| Line | DrvStrokePath Function, DrvStrokeAndFillPath Function |
| Surface | DrvFillPath Function, DrvStrokeAnd FillPath Function |
| Bitmap | DrvBitBlt Function, DrvStretchBlt Function, |
| | DrvStretchBitRop Function |

Referring to the embodiments of Table 1, the GDI unit 152 may be used to analyze the print data outputted from the application program unit 151. The GDI unit 152 may be used to call the “DrvStrokePath” function to represent lines with respect to the data determined to be a line object, and to call the “DrvFillPath” function to represent surfaces with respect to the data determined to be a surface object. Also, the GDI unit 152 may be used to output both the “DrvBitBlt” function to represent bitmaps and bitmap size information with respect to the data determined to be a bitmap object, for example. The bitmap size information may be area information.

According to an embodiment of the present general inventive concept, if the GDI banding function is requested, the GDI unit 152 may be used to transmit the respective objects of the print data that constitute one designated page (i.e., of corresponding print data) to the printer driver 153, and after the associated calling functions of the respective objects are called, the GDI unit 152 may be used to transmit the respective objects of the same designated page to the printer driver 153. Then, in accordance with a request from the printer driver 153, the GDI unit 152 may be used to transmit the objects of the subsequent pages (i.e., subsequent to the page already transmitted) to the printer driver 153.

Pursuant to an embodiment of the present general inventive concept, if the GDI banding function is requested by the printer driver 153, the GDI unit 152 may be used to transmit the objects of the print data to the printer driver 153 and to call the associated functions of the respective objects until, for example, the printer driver 153 requests an end of the banding function.

Hereinafter, the operation of the GDI unit 152 when the GDI banding function is requested by the printer driver 153 is described in detail, in accordance with an embodiment of the present general inventive concept.

If the GDI banding function is requested by the printer driver 153 and the size of a page fragment, for which the GDI banding function is to be performed, is received (or accessed) by the GDI unit 152, the GDI unit 152 may be used to prepare the banding function.

If a new start position information (e.g., 0, 0) of the page for which the GDI banding function is to be performed is received, for example, from the printer driver 153, the GDI unit 152 may be used to divide the print data into objects existing in a banding region of the print data. The banding region may be as large as a previous banding region. Also, the GDI unit may be used to call the associated DDI calling functions corresponding to the objects and/or to transmit those calling functions to the printer driver 153, together with the objects, for example. If the function calling for one banding region is completed, the GDI unit 152 may then be used to divide the print data existing in the next banding region by using the next start position information received from the printer driver 153, and then to repeat the above-described operation, as needed.

If information which indicates that the banding function is no longer needed (e.g., −1, −1) is received from the printer driver 153, the GDI unit 152 may be used to prepare the end of the banding function and to transmit the objects of the subsequent page or pages (or part thereof).

For example, if the page size, the size of a page fragment for which the GDI banding function is to be performed, and the corresponding start position information (e.g., 0, 0) of the page are received from the printer driver 153, the GDI unit 152 may be used to set the whole corresponding page into the appropriate banding regions. Then, the GDI unit 152 may be used to divide the print data into objects existing in the set banding region set from the start position information (e.g., 0, 0) of the corresponding page, and to call the associated DDI calling functions corresponding to the respective objects.

If the start position information (e.g., 0, 0) is transmitted from the printer driver 153, after the lapse of a specified time, the GDI unit 152 may be used to transmit the objects that constitute the print data of the same page and/or objects of the subsequent pages to the printer driver 153. Also, if end information such as (−1, −1) for a particular page is received at the GDI unit, the GDI unit 152 may be used to transmit the objects of the subsequent page or pages to the printer driver 153.

The printer driver 153 may be used to display a print registration information screen to set printing parameters such as the paper (or other suitable medium) size, print range, print quality, the number of copies, and so forth. A user can set the printing parameters supported by the image forming device 200 in more detail through the print registration information screen displayed on the display unit 125, for example.

In addition, the printer driver 153 may be used to convert the printing parameters and the print data provided from the GDI unit 152 into a printer language that can be interpreted by the image forming device 200. The printer language refers to commands that the print data output device 100 may transmit to the image forming device 200 in order to instruct how to construct the document to be outputted. Such commands may be used to manage the size of fonts, graphics, compression of data, color, and so forth.

For example, the printer language may be a printer control language PCL 5 to generate different associated commands for each of the objects that constitute the print data, PCL 6, PostScript (PS), and/or GDI language to convert one page of the print data into bitmap data. Samsung printer language (SPL) supported by Samsung may be an example of the GDI language.

Generally, since PCL is used to generate associated commands for each of the objects of the print data, it may be advantageous to use PCL in the case where the amount of page output data, such as text, lines, and/or surfaces, is small. However, in case where the amount of page output data is large, the data output speed may be lowered when using PCL.

Since the GDI language is used to generate bitmap data corresponding to a page of print data, the GDI language may be useful to improve the output speed in the case where the amount of the page output data is large.

The printer driver 153 may be used to support a plurality of printer languages. The printer driver 153 may be used to select an optimum printer language among the plurality of printer languages. Selection of the optimum printer language may be based on analyzing the characteristics of the print data. The selected optimum printer language may then be used to convert the print data into commands of the selected optimum printer language. Accordingly, it is possible for the printer driver 153 to collect the associated calling functions by receiving the objects of the print data of a page twice, the first time to analyze the objects using the received/collected associated calling functions and the second time to output the print data of objects using the selected optimum printer language and optionally using the GDI banding function of the GDI unit 152, for example.

That is, in order to analyze the respective objects that constitute the print data needed to select an optimum printer language, the printer driver 153 receives the objects of the corresponding page and the associated calling functions of the respective objects, and then receives the same objects again in order to convert the print data into the selected optimum printer language. In this case, the number of pages of print data twice received by a printer driver 153, for example, may be programmed so that it can be changed by a designer or a user, and the first page of print data may be set as a default value.

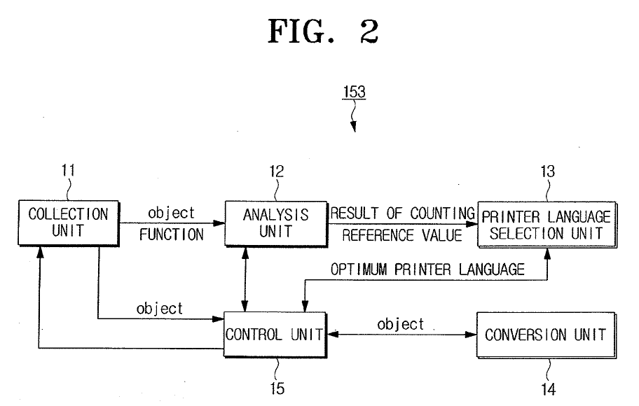

FIG. 2 is a block diagram illustrating a detailed construction of a printer driver as illustrated in FIG. 1, according to an embodiment of the present general inventive concept.

Referring to FIGS. 1 and 2, the printer driver 153 may be provided with a collection unit 11, an analysis unit 12, a printer language selection unit 13, a conversion unit 14, and a control unit 15, as illustrated.

If the printing parameters are received from the GDI unit 152, the collection unit 11 may be used to request the GDI banding function of the GDI unit 152, and to inform the GDI unit 152 of the size of the fragment of the page to be divided. Also, the collection unit 11 may be used to inform the GDI unit 152 of the start position information (e.g., 0, 0) of the page fragment.

For example, if the collection unit 11 is used to request the page fragment corresponding to the whole size of the page (e.g., A4 size)together with the print data of the first page, the collection unit 11 may be used to transmit the start position information (e.g., 0, 0), and the GDI unit 152 may be used to call the associated calling functions of the respective objects that constitute the print data of the first page.

When the associated calling functions of the respective objects that constitute the print data of the first page are called, the collection unit 11 may be used to collect the functions called for each of the objects. For example, the collection unit 11 may be used to collect the actual bitmap size information in the case of bitmap objects. The collection of the associated calling functions or the collection of the bitmap size information may be ended when the calling of the functions for the first page is completed.

Then, when or if it is determined that the output of the first page, for which the GDI unit 152 has requested the banding function, is completed, the analysis unit 12 may be used to count the number of times the associated calling functions of the corresponding objects is called in a count result by analyzing the collected functions, and to output a reference value to be used to select the optimum printer language to the printer language selection unit 13 based on the count result and the bitmap size information. The reference value, calculated for each of the objects (i.e., object types), may be used to select the optimum printer language.

In the case of bitmap objects, the reference value that may be used to select the optimum printer language is calculated by Equation (1).

$$\begin{matrix}\text{Equation 1:} & \\ First Reference Value = \frac{Bitmap Rate \times Printer Specification}{PC Specification} , here , bitman rate is 1.5 . & ( 1 )\end{matrix}$$

The PC specification is a constant calculated in proportion to the capacity of the CPU 130, the capacity of the RAM 145, and the capacity of the HDD 150. Also, the printer specification is a constant calculated in proportion to pages per minute (ppm) information of the image forming device 200. Referring to Equation (1), the first reference value is a reference value that is compared with the number of called associated calling functions of the counted bitmap objects (i.e., the count result corresponding to bitmap objects).

For example, PC Specification ∝ (CPU+RAM)×HDD=(3.00 GHz+512 MB)×80 GB,

Printer Specification ∝ PPM Information=35 ppm.

These are applicable to Equations 2 and 3 in the same manner.

According to the result of a test performed using PCL, with 109 files and 17 kinds of applications, by using a computer having specifications of Intel Pentium 4, CPU 3.00 GHz, and 512 MB memory, and a printer of 35 ppm, the output speed of the print data was reduced in the case where the bitmap size on the basis of a letter size page was over 1.5, and the average print speed (per page) was improved over 1.5 second in the case of using SPL. Accordingly, for SPL, the value of 1.5 was used as the bitmap rate during the calculation of the first reference value. Here, in the case of changing PCL 6 to SPL, it may be recognized that the first reference value is in proportion to the printer specifications and is in inverse proportion to the PC specifications, according to Equation (1).

In particular, in the case of using SPL with respect to an application program that uses a background having a large number of bitmaps such as PowerPoint, the data output speed was considerably increased as compared to using PCL. For example, in outputting a document in which the rate of the bitmaps existing on the background of a 19-page PowerPoint document is 1.8 per A4 size page, 138.88 seconds were needed in the case of using PCL, while 45.79 seconds were needed in the case of using SPL. Thus, 138.88 seconds to output using PCL was lowered to 45.79 seconds using SPL, in this example.

In the case of line/surface objects, the reference value that may be used to select the optimum printer language is calculated by Equation (2).

$$\begin{matrix}\text{Equation 2:} & \\ Second Reference Value = \frac{Number of Calls \times Printer Specification}{PC Specification} , here , the number of calls means the number of calls of line / surface functions , and is 800. & ( 2 )\end{matrix}$$

Referring to Equation (2), the second reference value is a reference value that is compared with the sum of the number of associated calling functions of the counted line objects and the number of the associated calling functions of the counted surface objects. The PC specification is a constant calculated in proportion to the capacity of the CPU 130, the capacity of the RAM 145, and the capacity of the HDD 150, as noted above. Also, the printer specification is a constant calculated in proportion to ppm information of the image forming device 200, as noted above.

According to a test performed using PCL, with 109 files and 17 kinds of applications, by using a computer having specifications of Intel Pentium 4, CPU 3.00 GHz, and 512 MB memory, and a printer of 35 ppm, the output speed of the print data was reduced in the case where the line/surface related functions called are over 800, on the basis of a letter size page. The average output speed per page was improved over 0.5 second in the case of using SPL over that of using PCL. Accordingly, the value of 800 was used as the number of calls of the line/surface functions during the calculation of the second reference value. Here, in the case of changing PCL 6 to SPL, it may be recognized that the second reference value is in proportion to the printer specification and is in inverse proportion to the PC specifications, according to Equation (2).

In the case of text objects, the reference value that may be used to select the optimum printer language is calculated by Equation (3).

$$\begin{matrix}\text{Equation 3:} & \\ Third Reference Value = \frac{Number of Calls \times Printer Specification}{PC Specification} , here , the number of calls means the number of calls of text functions , and is 200. & ( 3 )\end{matrix}$$

Referring to Equation (3), the third reference value is a reference value that is compared with the number of functions of the counted text objects. The PC specification is a constant calculated in proportion to the capacity of the CPU 130, the capacity of the RAM 145, and the capacity of the HDD 150, as noted above. Also, the printer specification is a constant calculated in proportion to ppm information of the image forming device 200, as noted above.

The calculated first to third reference values may be used without change unless the PC specification and/or the printer specification are changed. If the respective specification information is changed, the analysis unit 12 may be used to recalculate the first to third reference values. Also, the calculated first to third reference values may be expressed as binary data in the printer driver 153, or may be stored in a text file which may be accessed by the printer driver 153.

In addition, the analysis unit 12 may be used to add all the bitmap size information of the bitmap objects existing on the first page, and then to calculate the rate of the added bitmap size of the whole size of the first page (e.g., A4 size), i.e., the bitmap rate (bits per page).

The printer language selection unit 13 may be used to select the optimum printer language among the plurality of supportable printer languages by using the first to third reference values calculated by the analysis unit 12. The selection of the optimum printer language is based on the goal of improving (and/or optimizing) the printing speed by taking into account the size and type of print data to be printed.

In the case of PCL 6, the commands needed to print data are generated for each of the objects. When using SPL, bitmap data of a page is always generated. Even for a small amount of print data, the generated bitmap data is large. Thus, if the amount of the print data of a page is small, for example, the size of the print file (i.e., PRN file) is small on the whole. In such case, when the size of the print data is small, PCL 6 may be selected and used over SPL, because the size of the print file may be larger than that in the case of PCL 6.

If the page includes many lines or surfaces, a large number of printer commands are generated in the case of using PCL 6. By comparison, the size of the bitmap data is not greatly increased over a predetermined size in the case of using SPL. Accordingly, SPL may be more advantageous than PCL 6 in such instance when a page includes many lines and/or surfaces, for example.

If the page includes a large amount of text, the fonts in the image forming device 200 are used in the case of using PCL 6. Thus, the size of the print file becomes smaller than that in the case of using SPL. Accordingly, in the case where PCL6 and SPL are set as defaults to be used for the optimum printer language selection, it is preferable to use PCL 6 if the page includes a large amount of text. However, if the GDI language is set as a default language in addition to SPL, it may be preferable to use the GDI language in addition to SPL if the page includes a large amount of text.

On the other hand, if the page includes a large amount of bitmap print data, all the RGB data of the bitmap data is transmitted to the image forming device 200 in the case of using PCL 6. Thus, the size of the print file may be increased. By contrast, in the case of using SPL, the print file is generated as one bitmap data. Thus, the size of the print file of the whole page is not increased over the predetermined size even if a large amount of print data exists in bitmap form or the number of bitmaps is increased. In such case, it may be advantageous to use SPL to improve the print speed per page as compared to the use of PCL 6, for example

Hereinafter, the selection of the optimum printer language will be described in more detail, according to an embodiment of the present general inventive concept.

The printer language selection unit 13 may be used to assign a priority to the object (or objects) that exerts (or exert) the greatest influence upon the print data output speed, and to select the optimum printer language by comparing the respective number of objects (e.g., bitmap size, number of line objects, number of surface objects, number of text objects, etc.) with their corresponding reference values corresponding to the respective objects in the order of their assigned priority. Also, if three or more supportable printer languages are available, the printer language selection unit 13 may be used to select the optimum printer language after setting, as defaults, two printer languages (e.g., PCL6 and SPL) as having high priorities.

For example, if the printer language selection unit 13 is used to s priorities in the order of a bitmap object, a line/surface object, and a text object, then the printer selection unit 13 may be used to compare the bitmap size calculated for the bitmap objects with first reference value.

If the bitmap size exceeds the first reference value as the result of comparison, the printer language selection unit 13 may be used to select the GDI language as the optimum printer language. By contrast, if the bitmap size is less than or equal to the first reference value, the printer language selection unit 13 may be used to compare the number of associated line/surface calling functions called for the line and surface objects with the second reference value.

If the number of associated line/surface calling functions called exceeds the second reference value as the result of comparison, the printer language selection unit 13 may be used to select the GDI language as the optimum printer language. By contrast, if the number of associated line/surface calling functions called is less than or equal to the second reference value, the printer language selection unit 13 may be used to select PCL 6 as the optimum printer language.

However, if the GDI language is selected in addition to PCL 6 and SPL having been set as the two defaults, for example, the printer language selection unit 13 may be used to compare the number of associated text calling functions called for the text objects with the third reference value. If the number of associated text calling functions, exceeds the third reference value as the result of comparison, the printer language selection unit 13 may be selected the GDI language in addition to SPL as the optimum printer language; whereas, if the number of associated text calling functions called is less than or equal to the third reference value, the printer language selection unit 13 may be used to select PCL 6 in addition to the SPL language as the optimum printer language.

This is because if the print data is converted into a printer language by using PCL 6 in a state that the print data includes a large amount of text, the fonts existing in the image forming device 200 may be used, and, thus, the size of the print file (i.e., PRN file) can be minimized.

If the optimum printer language is selected through the above-described processes, the collection unit 11 may be used to transmit the start position information (e.g., 0, 0) to the GDI unit 152. The GDI unit 152 may be used to again transmit the respective objects that constitute the print data of the first page and to transmit the objects that constitute the print data of the subsequent pages to the conversion unit 14.

The conversion unit 14 may be used to convert the objects of the respective pages being transmitted into commands of the selected optimum printer language. If no further page (or part thereof) for which the banding function may be performed exists, i.e., if the conversion of the print data of the first page into the optimum printer language is completed, the collection unit 11 may be used to inform the GDI unit 152 of end information (e.g., −1, −1) to indicate that the collection unit 11 will not receive further print data after the conversion of the print data of the previous (or first) page into the optimum printer language is completed.

If the completion of the output of the first page is reported from the GDI unit 152, the control unit 15 may be used to count the number of times the associated calling functions called for each of the objects (e.g. each of the object types such as bitmap, line, surface, text, or other) by analyzing the collected functions, and to control the analysis unit 12 and the printer language selection unit 13 to select the optimum printer language based on the count result and the bitmap size information.

In addition, if the optimum printer language is selected by the printer language selection unit 13, the control unit 15 may be used to control the collection unit 11 to retransmit the start position information (e.g., 0, 0) to the GDI unit 152, and to output the objects provided from the GDI unit 152 to the conversion unit 14.

Referring again to FIG. 1, the spooler 154 may be used to spool the print data converted into the printer language by the printer driver 153, and to provide the spooled print data to the port monitor 160 to match the processing speed of the image forming device 200, for example.

The port monitor 160 may be used to monitor ports electrically and physically connected with the image forming device 200, and to provide the print data to the image forming device 200 through the connected ports.

The first communication interface unit 170 is provided with a plurality of ports, at least one of which is in bidirectional communication (see bidirectional arrow 10) with the image forming device 200, and used to transmit the printing parameters and print data converted into the printer language to the image forming device 200. The plurality of ports may include LPT ports, network ports, universal serial bus (USB) ports, and so forth.

Referring to FIG. 1, the image forming device 200, which is communicably connected with the print data output device 100, includes an operation panel unit 210, a ROM 220, a RAM 230, a storage unit 240, a second communication interface unit 250, a data processing unit 260, a print engine unit 270, and a control unit 280, as illustrated.

The operation panel unit 210 may be provided with user manipulation keys (not illustrated) and a display unit (not illustrated). The user manipulation unit (not illustrated) may have a plurality of keys to select and to set functions supported by the image forming device 200, for example, a touch panel, and so forth, and to apply the selected functions to the control unit 280. The display unit (not illustrated) may be used to display the operation state of the image forming device 200 under the control of the control unit 280.

The ROM 220 is a memory that may be used to store various kinds of control programs required to implement the functions of the image forming device 200, and the RAM 230 is a memory that may be used to store various kinds of data being generated during the operation of the image forming device 200.

The storage unit 240 may be used to store programs required to conduct the emulation of the print data.

The second communication interface unit 250 communicates with the print data output device 100, and may be used to receive the printing parameters and the print data transmitted from the first communication interface unit 170, as illustrated in FIG. 1.

The data processing unit 260 may be used to emulate the print data, which has been converted into the commands of the optimum printer language, so that the print data can be printed. For example, if the print data has been converted into the commands of PCL 6, the data processing unit 260 may be used to emulate the print data by using the PCL 6 emulation.

The print engine unit 270 may be used to perform a printing work under the control of the control unit 280.

The control unit 280 may be used to control the entire operation of the image forming device 200 according to the control programs stored in the ROM 220.

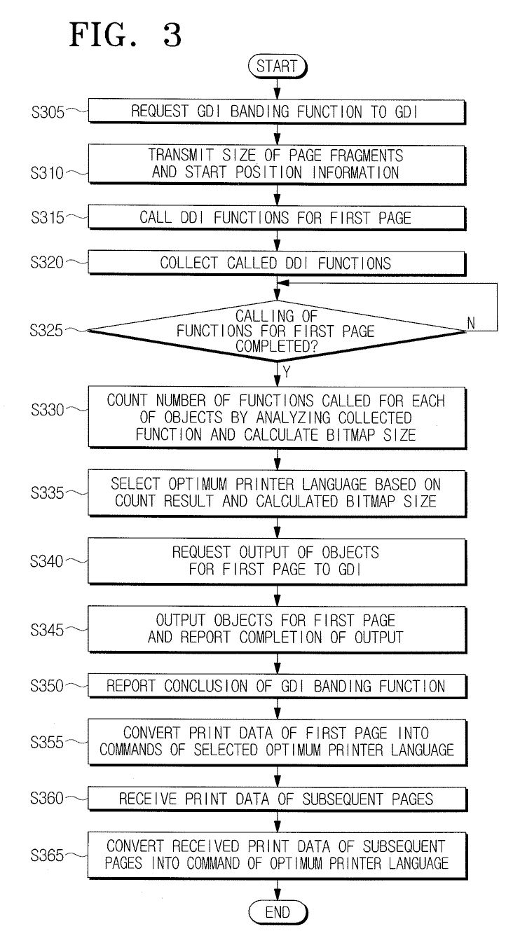

FIG. 3 is a flowchart illustrating a method of selecting a printer language that is supported by the device of FIG. 1, pursuant to an embodiment of the present general inventive concept.

Referring to FIGS. 1 to 3, if the print options are provided from the GDI unit 152, the collection unit 11 submits a request of the GDI banding function to the GDI unit 152 at operation (S305).

Then, the collection unit 11 informs the GDI unit 152 of the size of the page fragments and the start position information of the page fragments at operation (S310). For example, in the case when the entire size of one page is the size of the page fragment, the collection unit 11 submits a request for the output of the data for the first page of the document to the GDI unit 152. The data of the first page includes the respective objects of the print data that constitutes the first page and the associated DDI calling functions that are called corresponding to the objects.

If the DDI functions for the first page of the document are called from the GDI unit 152 at operation (S315), the collection unit 11 collects the called DDI functions at operation (S320). At operation (S315), the GDI unit 152 calls the DDI functions for each of the objects of the print data that constitutes the first page, and in the case of the bitmap objects, the GDI unit 152 provides the bitmap size information to the collection unit 11.

If the completion of the function calls for the first page, for which the banding has been requested, is reported by the GDI unit 152 at operation (S325), the analysis unit 12 counts the number of functions called for each of the objects by analyzing the functions collected at operation (S320), and outputs the count result of the associated calling functions of the objects and calculates the bitmap size the to be used for the optimum printer language selection to the printer language selection unit 13 at operation (S330).

The printer language selection unit 13 selects the optimum printer language among the plurality of supportable printer languages, based on a comparison of the count result and the calculated bitmap size to the first to third reference values at operation (S335), as noted previously herein, for example.

If the optimum printer language is selected at operation (S335), the collection unit 11 again requests the output of the print data (e.g., objects thereof) for the first page to the GDI unit 152 at operation (S340). The collection unit 11 also transmits the start position information of the first page to the GDI unit 152 with the request so that the GDI unit can identify which requested objects to output.

If the respective objects that constitute the print data of the first page are transmitted from the GDI unit 152 and the completion of the output of the first page is reported at operation (S345), the collection unit 11 transmits the end information (e.g., −1, −1) to indicate the end of the GDI banding function to the GDI unit 152 at operation (S350).

In addition, the conversion unit 14 converts the respective objects that constitute the print data of the first page into the commands of the optimum printer language at operation (S355).

Also, the GDI unit 152 transmits the output data for the print data of the subsequent pages following the first page to the collection unit 11 at operation (S360). That is, the GDI unit 152 transmits the respective objects that constitute the print data of the subsequent pages to the collection unit 11, and the conversion unit 14 converts the respective transmitted objects of the subsequent pages into the commands of the selected optimum printer language at operation (S365).

The data converted at operations (S355 and S365) is transmitted to the image forming device 200 to be printed.

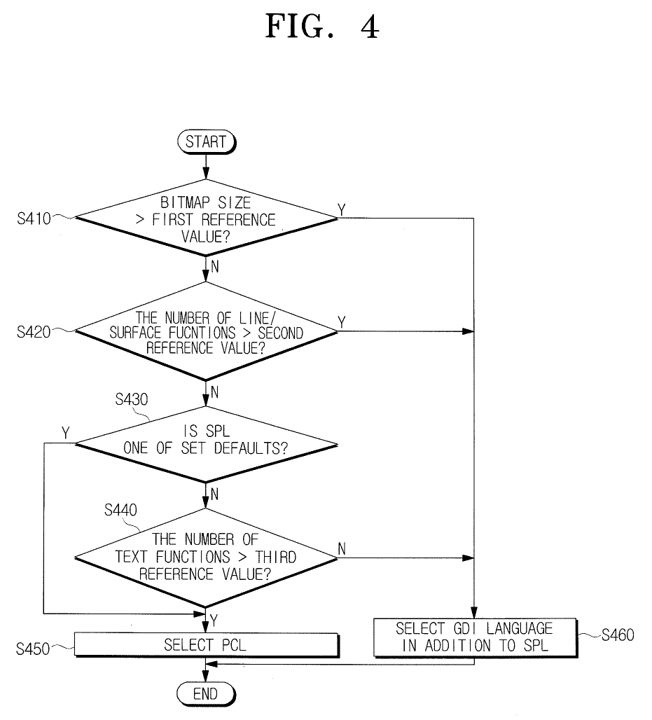

FIG. 4 is a flowchart illustrating operation S335 of selecting an optimum printer language of FIG. 3 in more detail, according to an embodiment of the present general inventive concept.

Referring to FIGS. 1 to 4, if the bitmap size calculated at operation (S330) is less than or equal to the first reference value at operation (S410), the printer language selection unit 13 compares the number of line/surface functions called for the line/surface objects with the second reference value at operation (S420). By contrast, if the bitmap size exceeds the first reference value at operation (S410), the printer language selection unit 13 selects the GDI language as the optimum printer language at operation (S460).

If the number of line/surface functions is less than or equal to the second reference value as the result of comparison, the printer language selection unit 13 confirms whether SPL has been set as a default at operation (S430). Also, if the number of line/surface functions exceeds the second reference value at operation (S420), the printer language selection unit 13 selects the GDI language as the optimum printer language at operation (S460).

If the SPL language is not set as a default, as the result of confirmation at operation (S430), the printer language selection unit 13 compares the number of text functions called for the text objects with the third reference value at operation (S440). Also, if SPL is set as a default at operation (S430), the printer language selection unit 13 selects PCL 6 as the optimum printer language at operation (S450)

If the number of the text functions exceeds the third reference value as the result of comparison, the printer language selection unit 13 selects PCL, which has been set as a default value, as the optimum printer language at operation (S450). Also, if the number of text functions is less than or equal to the third reference value at operation (S440), the printer language selection unit 13 selects the GDI language as the optimum printer language at operation (S460).

As described above, according to the print data output device capable of selecting a printer language and the method of selecting a printer language according to embodiments of the present invention, it is possible to select an optimum printer language among a plurality of printer languages supported by the printer driver, in consideration of the characteristics of the print data. Accordingly, by selecting the optimum printer language, the output speed of the print data can be improved.

In particular, when the associated calling functions called for each of the objects of the print data are collected, the optimum printer language can be selected, based on an analysis of the called associated calling functions collected of a single page of print data (or part thereof), for example, by using the banding function provided by GDI of Windows. Accordingly, the delay of time required to select the optimum printer language, which is caused by the collection of the functions of the whole page, can be eliminated, and thus the reduction of the output speed of the print data can be prevented.

For example, in the case of using the GDI banding function of Windows, the collection of the respective objects can be easily performed, and it is not necessary for the printer driver to separately store the function information of the print data. Accordingly, the optimum printer language can be selected more usefully and promptly.

Alternatively, by collecting the associated calling functions called of a whole page and selecting the optimum printer language based on analysis of the called functions collected, the optimum printer language can be selected more accurately.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A print data output device to select an optimum printer language, the device comprising:
a graphics device interface (GDI) unit to divide print data into objects and to call associated calling functions needed to output the objects; and
a printer driver to collect the associated calling functions of the objects and to count the number of times each associated calling function is called into a corresponding count result, to select the optimum printer language among a plurality of printer languages based on the corresponding count result, to receive the objects of the print data from the GDI unit, and to convert the received objects into the selected optimum printer language.

2. The device of claim 1, wherein the printer driver stops collection of the call functions and stops the count when the collection of the call functions for a first page of the print data is completed, and
when the printer driver selects the optimum printer language based on the count result of counting the call functions for the first page.

3. The device of claim 1, wherein the printer driver collects the call functions by using a GDI banding function of the GDI unit.

4. The device of claim 1, wherein the printer driver selects the printer language to convert the print data into bitmap data as the optimum printer language, if the corresponding count result of at least one of the called functions is greater than a set reference value.

5. The device of claim 1, wherein the printer driver selects as the optimum printer language a printer language to generate different commands for the respective objects that constitute the print data, if the corresponding count result of all the called functions is smaller than a set reference value.

6. The device of claim 5, wherein the selected optimum printer language is any one of a printer control language (PCL) and a PostScript (PS).

7. The device of claim 4, wherein each of the objects is at least one of a bitmap object, a line object, a surface object, and a text object, and
the printer driver selects the optimum printer language by comparing the number of the call functions of the bitmap objects, the number of the call functions of the surface objects, the number of the call functions of the line objects, and the number of call functions of the text objects, with the reference value, respectively.

8. The device of claim 4, wherein the reference value differs for each type of the objects.

9. A method of selecting a printer language, comprising:
dividing print data to be printed into objects having associated calling functions;
calling the associated calling functions to output the objects using a graphics device interface (GDI);
collecting the call functions of the objects and counting the number of times each associated calling function is called associated calling function in a corresponding count result;
selecting an optimum printer language among a plurality of printer languages based on the corresponding count result; and
receiving the objects of the print data from the GDI and converting the received objects into the selected optimum printer language.

10. The method of claim 9, wherein the collecting of the associated calling functions is stopped when the calling for a first page of the print data is completed, and when the optimum printer language is selected based on the count result for the first page.

11. The method of claim 9, wherein collecting the associated calling functions called is conducted using a GDI banding function of the GDI.

12. The method of claim 9, wherein selecting the optimum printer language comprises selecting the printer language to convert the print data into bitmap data as the optimum printer language if the corresponding count result of at least one of the called functions is greater than a set reference value.

13. The method of claim 9, wherein selecting the optimum printer language comprises selecting as the optimum printer language a printer language to generate different commands for the respective objects that constitute the print data, if the corresponding count result of the called functions is smaller than a set reference value.

14. The method of claim 13, wherein the selected optimum printer language is any one of a printer control language (PCL) and a PostScript (PS).

15. The method of claim 12, wherein each of the objects is at least one of a bitmap object, a line object, a surface object, and a text object, and
the selecting the optimum printer language comprises selecting the optimum printer language by comparing a bitmap size of the bitmap objects, the number of call functions of the surface objects, the number of call functions of the line objects, and the number of call functions of the text objects, with the reference value, respectively.

16. The method of claim 12, wherein the reference value differs for each type of the objects.

17. A print data output device to convert print data, divided into one or more different object types, into a selected printer language, the device comprising:
a printer driver to determine a corresponding count of each of the different object types, to select the printer language based on the corresponding count result, and to convert the print data using the selected printer language.

18. The print data output device of claim 17, wherein when the print data if converted into bitmap data exceeds a reference bit size value, the selected printer language is one selected to convert the print data into bitmap data.

19. The print data output device of claim 17, wherein the print data is of a size to print a complete page of print data.

20. The print data output device of claim 17, wherein when the corresponding count of at least one object type exceeds a reference value, the selected printer language is one selected based on the corresponding count that exceeds the reference value.

21. The print data output device of claim 20, wherein the selected printer language is one selected based on the corresponding count that most exceeds the reference value.

22. The print data output device of claim 17, wherein the different object types include at least one of a bitmap object, a line object, a surface object, and a text object.

23. A print data output device to convert print data, divided into one or more objects having at least one associated call function, into a selected printer language, the device comprising:
a printer driver to tally a corresponding count result of a corresponding total number for each associated call function, to select the printer language based on the corresponding count result, and to convert the print data into the selected printer language.

24. The print data output device of claim 23, further comprising a calling unit to transmit each object and to call and transmit each associated call function to the printer driver.

25. The print data output device of claim 24, wherein the printer driver collects each new associated call function needed to print the print data.

26. The print data output device of claim 25, wherein the calling unit is a graphics device interface.

27. The print data output device of claim 23, wherein the selected language is a printer control language or a PostScript language.

28. A method of selecting a printer language to convert print data, divided into one or more objects having at least one associated call function, comprising:
tallying a corresponding count result of a corresponding total number for each associated call function,
selecting the printer language based on the corresponding count result, and
converting the print data into the selected printer language.

29. The method of claim 28, further comprising:
transmitting each of the objects to a printer driver; and
calling and transmitting each associated call function to the printer driver.

30. The method of claim 29, wherein;
the transmitting of each object and the calling and the transmitting of each associated call function is conducted by a graphics device interface, and
the tallying is conducted by the printer driver.

31. The method of claim 30, further comprising:
collecting each associated new call function.

32. The method of claim 31, wherein the collecting is conducted by the printer driver.
